(19) United States
(12) Patent Application Publication
(10) Pub. No.: US 2015/0355346 A1
(43) Pub. Date: Dec. 10, 2015

(54) Composite Neutron Scintillator

(71) Applicant: NUCSAFE, INC., (US)

(72) Inventors: Kenneth Weston, Oak Ridge, TN (US); Floyd Wayne Garber, Oak Ridge, TN (US); John Newkirk, Knoxville, TN (US); Dustan Hollifield, Clinton, TN (US)

(73) Assignee: NUCSAFE, INC., Oak Ridge, TN (US)

(21) Appl. No.: 13/833,253

(22) Filed: Mar. 15, 2013

(51) Int. Cl. G01T 3/02; G01T 3/06

(52) U.S. Cl. CPC G01T 3/02; G01T 3/06

(57) ABSTRACT

Disclosed herein is a radiation scintillator configured for discrimination of thermal neutrons over gamma radiation and methods for making the same. The scintillator includes a non-scintillating base material and a plurality of spaced-apart micro-particles disposed in the base material. Each micro-particle includes a micro-particle base material, a neutron absorber that emits a neutron reaction product when exposed to thermal neutrons, and a scintillator dopant that emits a scintillation light when exposed to the neutron reaction product.

### FIELD

This disclosure relates to the field of radiation detectors. More particularly, this disclosure relates to neutron radiation scintillators.

### BACKGROUND

Neutron detectors are used in a number of industries and for scientific research. In the oil industry neutron detectors are used to detect oil producing formations. In the medical industry they are used for monitoring the dose of neutrons given to patients during boron neutron-capture therapy. Many major research facilities worldwide utilize neutrons detectors for various scientific goals, the most widely used application being atomic or molecular structure determination in materials science and biology. Scientific research on controlled thermonuclear fusion is another endeavor that relies on neutron detectors. Yet another application area of neutron detectors is for surveillance in nuclear and weapons storage facilities and other nuclear security applications. Special Nuclear Material is a term used to describe fissile materials that have the potential for direct use in a nuclear weapon or for use in the production of a nuclear material that may be used in a nuclear weapon. The presence of a significant amount of neutron radiation is usually an unambiguous indicator of the presence of certain Special Nuclear Materials. Consequently, neutron detectors may be used to detect Special Nuclear Material. Many neutron detector technologies have the problem that they also respond to gamma photons. Because many radionuclides used for medical, industrial, or other non-nuclear-weapon purposes emit gamma radiation, many neutron detectors that are used for security screening applications produce false neutron “alarms” due to exposure to strong gamma sources instead of exposure to neutron sources. What are needed therefore are neutron detector technologies that have improved gamma photon discrimination.

### SUMMARY

[symbol]

In one embodiment the present disclosure provides a neutron scintillator that includes a non-scintillating base material; and a plurality of spaced-apart micro-particles disposed in the base material. In this embodiment each micro-particle has a micro-particle base material, a neutron absorber material that emits a neutron reaction product when exposed to thermal neutrons, and a scintillator dopant that emits scintillation light when exposed to the neutron reaction product.

A further embodiment provides neutron scintillator that has a non-scintillating base material that is substantially transparent to a scintillation light having a scintillation wavelength. This embodiment further includes a plurality of coated micro-particles disposed in the base material, wherein each coated micro-particle in the plurality of coated micro-particles has (a) a core that has a neutron absorbing material that emits a neutron reaction product when exposed to thermal neutrons and a scintillator dopant that emits the scintillation light when exposed to the neutron reaction product, where the neutron reaction product has a penetration range in the core, and (b) a coating disposed around the core that is substantially transparent to the scintillation light and that has a minimum thickness that is approximately equal to the penetration range of the neutron reaction product in the core.

Further provided herein is a method of making a neutron scintillator that includes fabricating a plurality of micro-particles, where each micro-particle has a micro-particle refractive index and each micro-particle has (a) a micro-particle base material, (b) a neutron absorber material that emits a neutron reaction product when exposed to thermal neutrons, and (c) a scintillator dopant that emits a scintillation light at a scintillation wavelength when exposed to the neutron reaction product. This method embodiment further includes disposing the micro-particles in a base material that is substantially transparent to the scintillation light and is that is non-scintillating.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a somewhat schematic illustration of a scintillator.

FIGS. 2 and 3 are somewhat schematic illustrations of micro-particles for use in a scintillator.

FIGS. 4A, 4B, 4C and 5 are somewhat schematic illustrations of coated micro-particles for use in a scintillator.

FIG. 6 is a somewhat schematic illustration of a double-coated micro-particle for use in a scintillator.

FIG. 7 is a flow chart for a method of making a scintillator.

### DETAILED DESCRIPTION

In the following detailed description of the preferred and other embodiments, reference is made to the accompanying drawings, which form a part hereof, and within which are shown by way of illustration the practice of specific embodiments of neutron scintillators and methods of making same. It is to be understood that other embodiments may be utilized, and that structural changes may be made and processes may vary in other embodiments.

Neutron scintillators may be fabricated from material that includes a neutron absorber such as ⁶Li or ¹⁰B and a scintillator dopant such as trivalent cerium (Ce³⁺). Other suitable neutron detecting materials may include those containing at least one of the elements ⁶Li, ¹⁰B, Gadolinium, Uranium-233, Uranium-234, Uranium-235, Uranium-236, Neptunium-237, Plutonium-239, Plutonium-240, Thorium-232, and Americium-241. Certain rare earths (e.g. Tb, Tm, Dy, Ho, Er, Nd, Pr, La, Eu, and Sm) may also be used for doping of glasses to make luminescent materials. There are also many other scintillator options that may be used, including particles that include any gamma scintillator crystal.

⁶Li loaded scintillators detect neutrons via a ⁶Li (n,α) reaction which produces an alpha particle and triton with Q value 4.78 MeV. ¹⁰B loaded scintillators detect neutrons via a ¹⁰B (n,α) reaction what produces an alpha particle. The alpha and triton are examples of a “neutron reaction product” from a neutron absorption event. The alpha and triton deposit energy into their immediate surroundings causing electronic excitation of nearby scintillator dopant Ce³⁺ ions. As the excited state scintillator dopant Ce³⁺ ions relax back to their ground electronic state, each emits a visible photon (typically λ=380 nm-700 nm). The resultant flash of light (scintillation) is detected using a photodetector.

Gamma radiation may create energetic photoelectrons or Compton recoil electrons which may also cause electronic excitation of the scintillator dopant Ce³⁺ ions and scintillation light. Thus neutron scintillators are generally also gamma scintillators. These gamma scintillation events from common sources of gamma interference generally produce much smaller scintillation photon bursts than the neutron scintillation events, but even so, there is generally some overlap in the burst height distributions for the two types of scintillation events. The problem of distinguishing between neutron scintillations and gamma scintillations is exacerbated in a high (e.g., 10 mR/h) gamma background environments that may be encountered in nuclear material security applications or other situations where neutrons must be detected in a large gamma background.

To address this problem it is helpful to employ neutron scintillator micro-particles that are supported in a base material. An embodiment of such an arrangement is depicted in FIG. 1, which illustrates a scintillator 10 with a plurality of neutron scintillator micro-particles 14 that are dispersed in a base material 18.

A scintillator is a material that exhibits scintillation (i.e., luminescence) when excited by ionizing radiation. A scintillator emits light at one or more wavelengths when exposed to ionizing radiation. As used herein the term “non-scintillating” means a material that either (a) does not luminesce in the presence of ionizing radiation or (b) does luminesce in the presence of ionizing radiation, but its low light yield and/or negligible transparency to its own light emissions results in negligible light transmission from the center of the material to the edge of the material.

The neutron scintillator micro-particles 14 contain a neutron absorber and a scintillator dopant. When exposed to neutrons, the neutron scintillator micro-particles 14 emit scintillation light. In a preferred embodiment, the neutron scintillator micro-particles 14 are made of a silicate glass that contains ⁶Li in the forms of ⁶Li₂O (lithia) and the scintillator dopant is a trivalent cerium (Ce³⁺) in the form of cerium(III) oxide. In alternate embodiments different forms of ⁶Li and/or trivalent cerium may be provided. In alternate embodiments other glass materials or similar materials may be substituted for the silicate glass. Also, as previously noted, in alternate embodiments ¹⁰B may be used in place of the ⁶Li as the neutron absorber. The neutron scintillator micro-particles 14 typically have a small size, such as an average dimension that is in a range of ≈50-250 μm, and preferably with a narrow size distribution within that range. In some embodiments the micro-particles 14 have an average dimension that is in a range of ≈50-150 μm. As used herein the term “micro-particle” refers to an article having a maximum dimension that is not more than five times its minimum dimension, and the term “average dimension” refers to the maximum dimension of a micro-particle plus the minimum dimension of the micro-particle, divided by two. The “maximum dimension” is the longest linear path through the centroid of the micro-particle and the “minimum dimension” is the shortest linear path through the centroid of the micro-particle.

The size of the neutron scintillator micro-particles has important implications for the scintillation characteristics, especially concerning discrimination of neutron-derived scintillation events from gamma-derived scintillation events. Under circumstances where the gamma radiation is from a naturally occurring or medical-use radiation source, the penetration range of energetic electrons created by the gamma interactions is generally much larger (greater than 150 μm) than the penetration range of the alpha and triton particles produced by the ⁶Li (n,α) reaction (which is typically less than 50 μm). By using small, isolated scintillator micro-particles 14, the distance that a gamma recoil electron may travel through scintillating medium is limited by the particle size, which in turn limits the amount of energy that can be deposited into the scintillator and ultimately limits the scintillation brightness (i.e. the number of photons created) of gamma-derived scintillation events. This benefit is enhanced by using scintillator micro-particles 14 that have a small maximum dimension, such as a maximum dimension of ≈150 μm. It is also important to note that by using scintillator micro-particles instead of micro-fibers, the distance that a gamma recoil electron may travel through Ce³⁺ containing glass is limited in 3 dimensions, rather than just 2 dimensions as would be the case if micro-fibers were used.

In contrast with Compton recoil electrons, the tritons and alpha particles (which are the result of neutron interactions) have much shorter ranges. The maximum penetration range of a triton in silicate glass is estimated at 40 μm from the initial point of neutron absorption before full energy deposition occurs. The alpha particles have an even smaller estimated penetration range of 7 μm. Consequently, most of the tritons and the alpha particles deliver the majority of their excitation energy from the neutron absorption events to Ce³⁺ ions in the neutron scintillator micro-particles 14.

These principles provide a significant advantage for the scintillator 10 depicted in FIG. 1. To enhance the advantage, the space between scintillator micro-particles 14 should be sufficiently large to minimize the likelihood that an individual energetic recoil electron will traverse more than one scintillator micro-particle before its kinetic energy is fully deposited. To ensure that the scintillator micro-particles 14 are isolated, they should be dispersed throughout the base material 18. For example, in the embodiment of FIG. 1, each scintillator micro-particle 14 in the plurality of scintillator micro-particles 14 is well separated from every other scintillator micro-particle 14, in the sense that the spacing between the scintillator micro-particles 14 is longer than the penetration range of Compton recoil electrons through the specific selected base material 18. At a minimum, each of the plurality of micro-particles should not be in physical contact with another micro-particle.

Scintillation light must reach a photodetector that is adjacent an edge of the scintillator 10 in order to register the scintillation events. This can be accomplished by using a base material 18 that is substantially transparent to the scintillation light generated by the scintillator dopant. As used herein the term “substantially transparent” means that at least 5 percent of the scintillation light generated by a scintillator micro-particle 14 in the center of scintillator 10 (where the scintillation light transmission is unobstructed by other scintillator micro-particles 14) reaches the edge of the scintillator 10 that is adjacent the photodetector Optically clear polymers are materials that generally will satisfy these requirements, though glass or sol-gels may also be used. Having 50% of the scintillation light generated by a scintillator micro-particle 14 in the center of scintillator 10 reach the edge of the scintillator 10 is about the absolute maximum amount of “transparency” that could be expected. In the first place, 50% of the light starts out propagating away from the photodetector and has to reflect back to ever get there. Much light may be lost at the scintillator walls, and this has nothing to do with the transparency of the material, but instead the exterior polish, wrapping, or coating used, or the housing it is in. Systems where less than 5 percent of the scintillation light generated by a scintillator micro-particle in the center of scintillator reaches the edge of the scintillator may work particularly if transparency is uniform across the whole composite scintillator and/or if the geometry and wall reflections of the scintillator are chosen such that the amount of light collected from any given location is very consistent.

The scintillator micro-particles 14 inherently have a micro-particle refractive index across the wavelength range of the scintillation light and the base material 18 inherently has a base material refractive index across the wavelength range of the scintillation light. Since the performance of the scintillator 10 relies on efficient transmission of light from the neutron scintillator micro-particles to a photodetector it is beneficial if the refractive index of the scintillator micro-particles 14 and the refractive index of the base material 18 are as closely matched as possible across the wavelength range of the scintillation light to reduce scattering of light within the scintillator 10. The more light is redirected due to scattering, the longer the average path the light must take to reach a photodetector, which means it becomes more likely that scintillation photons are lost due to being absorbed in the scintillator 11 or escaping from the sides of the scintillator 11. For purposes described herein the refractive indices of two materials are substantially matched if the refractive index of one material is within ±0.03 of the refractive index of the other material when the refractive indices are measured at room temperature using light across the wavelength range of the scintillation light. If the distance that scintillation light must travel through the scintillator 10 to reach the photodetector is short, then matching the refractive indices of the scintillator micro-particles and the refractive index of the base material becomes less important.

Another advantageous characteristic of the base material 18 is that it have a low effective atomic number (Z), since gamma rays are not efficiently attenuated by materials with low Z. This may reduce the likelihood that gamma energy will interact with the base material 18 and create Compton electrons. On the other hand, neutrons are somewhat moderated (slowed down) by low Z materials, so a low Z material may enhance the likelihood of absorption by the neutron absorber in the scintillator micro-particles 14.

Another embodiment employs a wavelength shifting material in place of the base material within which the scintillating micro-particles are suspended. A photo-fluorescent material may be used that is capable of absorbing higher frequency photons and subsequently emitting lower frequency photons. The wavelength shifting material absorbs scintillation light emitted from the neutron scintillator micro-particles and re-emits light at a longer wavelength. The longer wavelength light can propagate through the composite material with reduced absorption and scattering losses and therefore longer distances, and thus may enable improved performance and may enable the use of larger and more sensitive neutron scintillators. Shifting the scintillation light to longer wavelengths may also be beneficial since alternative photodetectors (e.g. silicon-based semiconductor junction photodetectors) that detect the longer wavelength light (λ=500 nm-1100 nm) very efficiently, but are too insensitive to detect the non-wavelength-shifted light predominantly at shorter wavelengths of direct Ce³⁺ emission, which peaks at λ≈390 nm-440 nm. The photodetectors used for wavelength-shifted light may also be beneficial due to being lower in cost, smaller, more rugged, and may have higher overall detection quantum yield.

The wavelength shifting material may be present homogeneously throughout the base material 18 or may be present in localized concentrations such as particles, fibers, films or slabs embedded in or adjacent to the scintillator micro-particles 14. In one embodiment, wavelength shifting optical fibers may be contained within the scintillator 10. Light emitted from the scintillator micro-particles propagates into the wavelength shifting optical fibers and is absorbed by the wavelength shifting material, thereby producing a wavelength-shifted light. A portion of the wavelength-shifted light is captured within a core of the fiber by total internal reflection at the interface of the core and a cladding of the fiber. The wavelength-shifted light then propagates down the fiber a distance before being detected by a photo detector placed at one or both ends of the fiber.

The use of a wavelength shifting material such as an optical fiber is advantageous when the transmission distance of the wavelength shifted light in the wavelength shifting optical fiber is long compared to the transmission distance of the primary scintillation light in the base material and permits detection of light from a larger portion of the scintillator with increased uniformity in photon detection efficiency when neutrons are detected by the scintillator.

The wavelength shifting material also advantageously delivers light to the photodetector through the wavelength shifting material allowing a photodetector with a relatively small active area because the photodetector only has to utilize an active area that corresponds in size to the wavelength shifting material, such as one or more optic fibers. Photodetectors having smaller active areas are less expensive and have enhanced performance by detecting light faster and having a lower noise floor when compared to photodetectors having a larger active area. Other exemplary wavelength shifting materials may be in the form of a rod, sheet, or slab placed inside or adjacent the micro particles 14 and serve as a light guide to facilitate the detection of neutron scintillation events in a micro-particle based scintillator that is much larger than may otherwise be allowed due to limited transmission distance in the micro-particle scintillator.

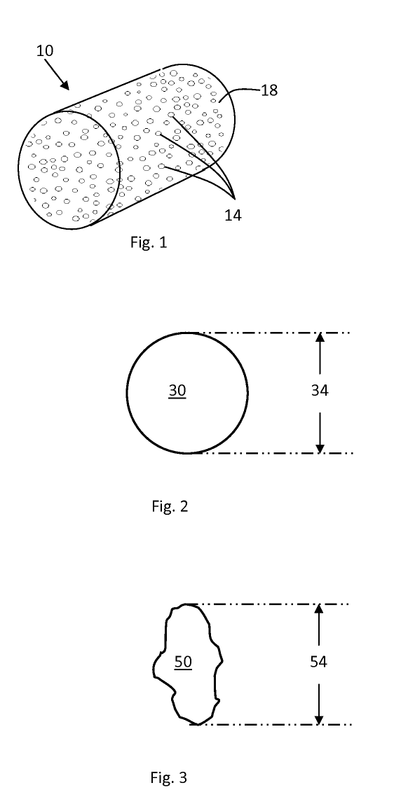

A cross-section taken through any of the scintillator micro-particles 14 of FIG. 1 may be circular, curvilinear, irregular, or polytopic (i.e., a geometric object with flat sides, which may exist in any number of dimensions), or may be formed as a combination of circular and/or curvilinear and/or irregular and/or polytope segments. FIG. 2 illustrates a spherical neutron scintillator micro-particle 30 that has a circular cross section with a diameter 34 that is in a range between 50-250 μm.

Materials described in the reference “Neutron detection with glass scintillators”, Nuclear Instruments and Methods 17 (1962) 97-116; L. M. Bollinger and G. E. Thomas, the entirety of which is incorporated by reference herein, are examples of compositions of materials suitable for fabrication of the neutron scintillator micro-particles 30 (or any other shaped scintillator micro-particles such as the scintillator micro-particles 14 of FIG. 1). A broad array of mechanical grinding methods may be used (such as commercially available tools from companies such as Retsch GmbH) to reduce the material to particle sizes of the targeted dimensions. Alternatively, the neutron scintillating materials can be formed into spherical particles. Examples of methods that have been used to make spherical glass microparticles are disclosed in U.S. Pat. No. 2,334,578 “Method of and apparatus for producing glass beads”, Rudolf Potters, Nov. 16, 1943 and U.S. Pat. No. 3,150,947 “Method for production of glass beads by dispersion of molten glass” Charles C Bland, Sep. 29, 1964, the entireties of which are incorporated by reference herein.

FIG. 3 illustrates a scintillator micro-particle 50 that is irregular in shape. The scintillator micro-particle 50 has a maximum diameter 54 that is in a range between 50-250 μm.

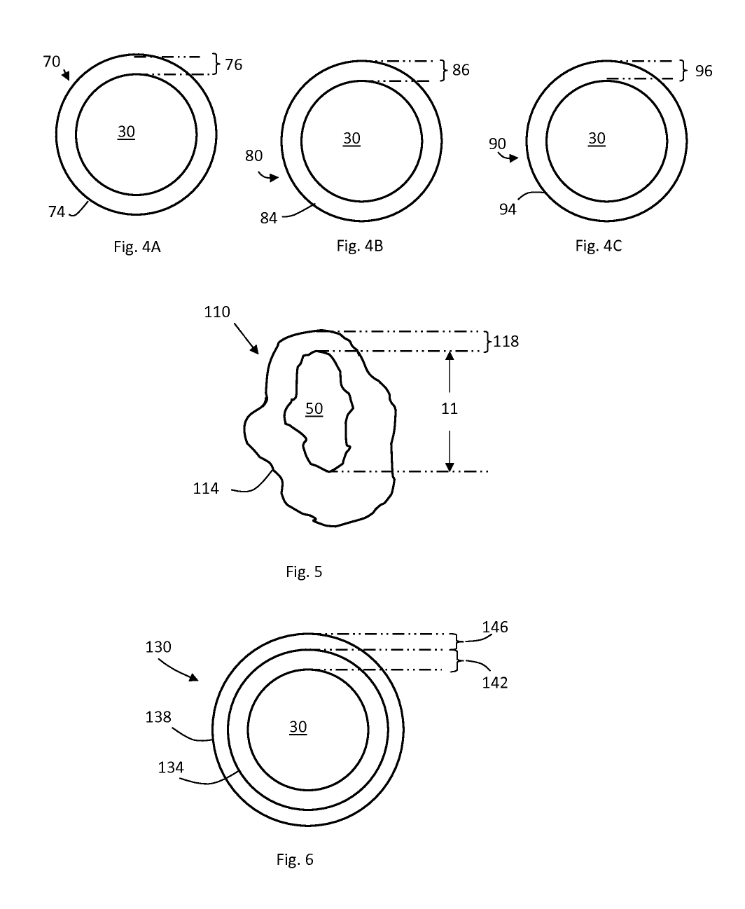

FIG. 4A illustrates a coated micro-particle 70 that is spherical in shape. The coated micro-particle 70 has a spherical neutron scintillator micro-particle 30 of FIG. 1 as its core. The coated micro-particle 70 has a passive coating 74 disposed around the spherical neutron scintillator micro-particle core 30. As used herein the term passive coating refers to a material that is substantially transparent to the scintillation light that is emitted by the scintillator dopant, and that contains no material that radio-chemically interacts with ionizing radiation. The spherical neutron scintillator micro-particle core 30 has a core refractive index, and the passive coating 74 has a coating refractive index that is preferably substantially matched to the refractive index of the scintillator micro-particle core 30 across the wavelength range of the scintillation light.

Preferably, the passive coating 74 is a low-Z polymer and is non-scintillating. The passive coating 74 has a minimum thickness 76, and preferable the minimum thickness 76 is approximately equal to or greater than the penetration range of gamma-derived photoelectrons or Compton electrons in the passive coating 74. Generally the minimum thickness 76 is within a range of 50-500 μm. The coated micro-particles may then be closely packed while maintaining a minimum distance between the neutron scintillator micro-particles 30 of the scintillator micro-particles 70 that is equal to twice the thickness 76 of the passive coating 74. This enables control of the spacing between neutron scintillator micro-particles 30 and thus control of the gamma-derived recoil electron scintillation brightness while at the same time maximizing the number density of scintillator micro-particles in the material.

As previously noted, the tritons that deliver most of the excitation energy from the neutron absorption events to Ce³⁺ ions have a travel distance in glass that is approximately 40 μm from the initial point of neutron absorption before full energy deposition occurs. Neutrons that absorb near the edges of a micro-particle core 30 will yield alpha and triton particles that leave the Ce³⁺-containing glass and result in smaller photon bursts that may be mistaken for gamma scintillation. The proportion of neutrons that deposit only a portion of their full energy in the scintillating glass increases as the particle size is decreased.

This may be mitigated to a degree as illustrated in FIG. 4B by fabricating a coated particle 80 having the spherical neutron scintillator micro-particle 30 of FIG. 1 as its core, and an active coating 84 that contains Ce³⁺ but no ⁶Li. As used herein the term “active coating” refers to a material that luminesces when subjected to neutron reaction products. By coating the spherical neutron scintillator micro-particles 30 with an active coating (such as the active coating 84) a more uniform scintillation brightness per neutron absorption event may result. Thus, the neutron response pulse height peak position will be higher and the distribution narrowed, providing another pathway to improved neutron sensitivity and neutron/gamma discrimination. The active coating 84 has a minimum thickness 96 that is approximately the penetration range of neutron reaction products in the material, which for triton in glass is approximately 40 μm. Because the active coating may also increase gamma-derived scintillation brightness due to recoil electron penetration in the coating layer, there is a trade-off expected in performance in adding this layer. A core and active coating thickness may be selected that yields the best possible performance in terms of neutron sensitivity and neutron-gamma discrimination for a given application.

Alternately, as depicted in FIG. 4C improved neutron sensitivity and neutron/gamma discrimination also may be realized by ⁷Li coated particle 90. The ⁷Li coated particle 90 has a ⁷Li coating 94 comprising the same material (including the Ce³⁺) that is used in the spherical neutron scintillator micro-particle 30, except that ⁷Li is used instead of ⁶Li. Natural lithium may be used in the ⁷Li coating 94 since it is predominantly (92.5%) ⁷Li.

The coating 82 should be thick enough to absorb neutron reaction products from neutrons absorbed near the surface of the micro-particle core 30, but thin enough so that Ce³⁺ scintillations in the coating 82 in response to recoil electrons are minimized. It may be beneficial to favor thinness over neutron reaction product absorption.

FIG. 5 illustrates a coated micro-particle 110 that has an irregular shape. The coated micro-particle 110 has the micro-particle 50 of FIG. 3 as its core. The coated micro-particle 110 has a coating 114. The coating 114 is preferably a material that is substantially transparent to the scintillation light that is emitted by the scintillator dopant. The coating 114 refractive index is preferably substantially matched to the refractive index of the scintillator micro-particle core across the wavelength range of the scintillation light. Preferably the coating 114 has a minimum thickness 118 that is approximately equal to the penetration range of the neutron reaction products (e.g., tritons) in coating material. Generally the minimum thickness 118 is in a range of 10-50 μm. The other general and preferred properties described with respect to the coating 82 of the micro-particle 70 of FIG. 4B also pertain to the coating 102 of the micro-particle 90 of FIG. 5.

In some embodiments both an active coating and a passive coating may be employed around a core to form a double-coated micro-particle. FIG. 6 illustrates such an embodiment where a double-coated micro-particle 130 includes the spherical neutron scintillator micro-particle 30 of FIGS. 2 and 4. The double-coated micro-particle 130 has a first coating 134 that is active, scintillating, but non-neutron absorbing. For example, the first coating may have the same composition as either the active coating 84 of FIG. 4B or the ⁷Li coating 94 of FIG. 4C. The first coating 134 has a minimum thickness 142 that is approximately the penetration range of neutron reaction products in the material, which is typically 40 μm for triton in glass. Typically the minimum thickness 142 will be in a range between 10 and 50 μm. A second coating 138 is a passive material that does not scintillate. Generally the minimum thickness 138 is within a range of 50-500 μm.

In the embodiment of FIG. 6 the active coating (i.e., the first coating 134) is disposed adjacent the neutron scintillator micro particle (i.e., the spherical neutron scintillator micro-particle 130) and the passive coating (i.e., the second coating 138) is disposed adjacent the outer surface of the active coating. In embodiments where both an active coating and a passive coating are used, both coatings are “disposed around the core” regardless of which coating is disposed adjacent the core. It is important to understand that while FIG. 6 depicts a spherical micro-particle 130, in an alternate embodiment micro-particles (including coated micro-particles) may be irregularly-shaped, such as exemplified by micro-particle 50 in FIG. 3 and micro-particle 110 in FIG. 5.

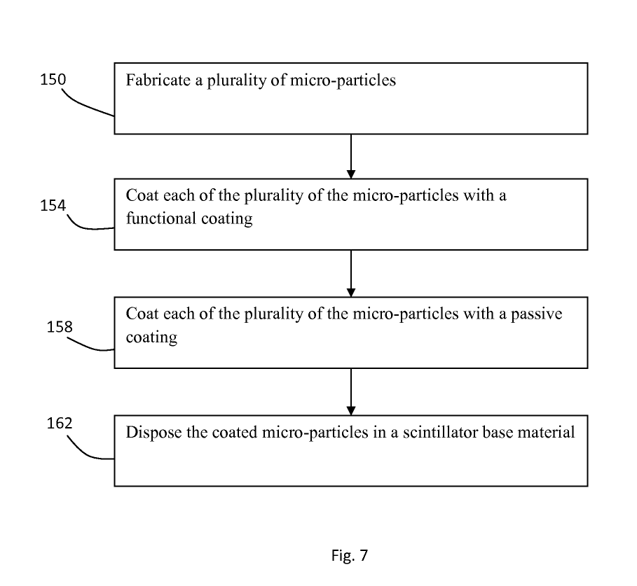

FIG. 7 depicts a method of making a neutron scintillator. A step 150 involves fabricating a plurality of micro-particles. In most embodiments each micro-particle includes a micro-particle base material, a neutron absorber material that emits alpha particles and tritons when exposed to neutrons, and a scintillator dopant that emits scintillation light when a neutron is absorbed. For example, cylindrically-shaped scintillator micro-particles may be fabricated by severing very small pieces of an optical fiber, such as by cutting the fiber with a laser. Irregular-shaped scintillator micro-particles may be formed by grinding, milling or pulverizing bulk materials having the chemical composition of the desired micro-particles.

In an optional step 154 an active coating may be applied to each of the plurality of the micro-particles from step 150. Typically the active coating is a 10-50 μm thick scintillating coating of a material that does not contain a neutron absorber, and that is substantially transparent to the scintillation light and that has a coating refractive index that substantially matches the refractive index of the scintillator micro-particle core material across the wavelength range of scintillation light.

In an optional step 158 each of the plurality of the micro-particles (from either step 150 or step 154) is coated with a 50-500 μm thick coating of a non-scintillating material that is substantially transparent to the scintillation light and that has a coating refractive index that substantially matches the refractive index of the scintillator micro-particle core material across the wavelength range of scintillation light.

In step 162 the coated micro-particles from either step 150, 154, or 158 are embedded in a base material that is non-scintillating with respect to ionizing radiation and that is substantially transparent to the scintillation light, and has a refractive index that substantially matches the refractive index of the scintillator micro-particle across the wavelength range of scintillation light.

With respect to applications of a polymer (e.g., passive) coatings, exemplary techniques for coating micro-beads (micro-spheres) with various materials with a tunable thickness that may be used to apply a coating layer to micro-particles in the size range that are relevant to a composite neutron detector are provided in U.S. Pat. No. 5,767,826 “Subtractive color twisting ball display” Jun. 16, 1998 N. K. Sheridon, and G. G. Robertson. Another example is provided in published US patent application US 2012/0156252 A1 “METHOD OF PRODUCING MICROBEADS”, Andre Brodkorb et al. With respect to applications of glass (e.g., active) coatings, exemplary techniques are provided in “Microspheres with Tunable Refractive Index by Controlled Assembly of Nanoparticles”, by Shin-Hyun Kim, et. al. Advanced Materials 2008, 20, 3268-3273. The publications cited in this paragraph are incorporated by reference in their entirety herein.

In summary, embodiments disclosed herein provide a composite material containing 50-250 μm diameter neutron scintillator particles, suspended in a substantially transparent and refractive index matched base material. Both the neutron absorption and the scintillation occur in the same material, which is a more efficient means of producing good light yield and uniform light yield for most neutron absorption events. Nonetheless, because of the geometric configuration of various embodiments (e.g., very small dispersed scintillating micro-particles) such compositions may be used for neutron scintillation detectors that have significantly reduced gamma ray sensitivity compared with the scintillator material alone. Furthermore, with such systems no pulse shape discrimination is generally needed in the scintillation detection system. Consequently, the composite material may be used to fabricate low-cost neutron detectors suitable for situations where it is desirable that neutrons be detected in a high gamma background without the gamma response significantly influencing the detected neutron rate.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A neutron scintillator comprising:
a non-scintillating base material; and
a plurality of spaced-apart micro-particles disposed in the base material, each micro-particle comprising:
a micro-particle base material,
a neutron absorber material that emits a neutron reaction product when exposed to thermal neutrons, and
a scintillator dopant that emits a scintillation light when exposed to the neutron reaction product.

2. The neutron scintillator of claim 1 wherein:
the scintillation light has a scintillation wavelength;
the base material has a base material refractive index at the scintillation wavelength; and
the micro-particles have a micro-particle refractive index at the scintillation wavelength that is substantially the same as the base material refractive index at the scintillation wavelength.

3. The neutron scintillator of claim 1 wherein for each micro-particle the neutron reaction product has a penetration range and the average dimension of each micro-particle is less than the penetration range.

4. The neutron scintillator of claim 1 wherein each micro-particle has a maximum diameter of from about 50 μm to about 250 μm.

5. A neutron scintillator comprising:
a non-scintillating base material that is substantially transparent to a scintillation light having a scintillation wavelength; and
a plurality of coated micro-particles disposed in the base material, wherein each coated micro-particle in the plurality of coated micro-particles comprises:
a core comprising a neutron absorbing material that emits a neutron reaction product when exposed to thermal neutrons and a scintillator dopant that emits the scintillation light when exposed to the neutron reaction product, wherein the neutron reaction product has a penetration range in the core, and
a coating disposed around the core that is substantially transparent to the scintillation light and that has a minimum thickness that is approximately equal to the penetration range of the neutron reaction product in the core.

6. The neutron scintillator of claim 5 further comprising a second coating disposed around the core, the second coating comprising a second scintillator dopant that emits the scintillation light when exposed to the neutron reaction product.

7. The neutron scintillator of claim 5 wherein:
the base material has a base material refractive index at the scintillation wavelength; and wherein
for each coated micro-particle,
the core has a core refractive index at the scintillation wavelength that substantially matches the base material refractive index at the scintillation wavelength, and
the coating has a coating refractive index at the scintillation wavelength that substantially matches the base material refractive index at the scintillation wavelength.

8. The neutron scintillator of claim 5 wherein for each micro-particle the neutron reaction product has a penetration range and the average dimension of each micro-particle is less than the penetration range.

9. The neutron scintillator of claim 5 wherein each core has a maximum diameter in a range between 50-250 μm.

10. The neutron scintillator of claim 5, wherein the coating comprises a second scintillator dopant that emits the scintillation light when exposed to the neutron reaction product.

11. A method of making a neutron scintillator comprising:
(a) fabricating a plurality of micro-particles each micro-particle having a micro-particle refractive index and each micro-particle comprising:
a micro-particle base material,
a neutron absorber material that emits a neutron reaction product when exposed to thermal neutrons, and
a scintillator dopant that emits a scintillation light at a scintillation wavelength when exposed to the neutron reaction product; and
(b) disposing the micro-particles in a base material that is substantially transparent to the scintillation light and is that is non-scintillating.

12. The method of claim 11 further comprising coating each of the plurality of micro-particles with a coating that is substantially transparent to the scintillation light to form coated micro-particles, wherein step (b) comprises disposing the coated micro-particles in the base material.

13. The method of claim 11 further comprising coating each of the plurality of micro-particles with a coating comprising a second scintillator dopant that emits the scintillation light when exposed to the neutron reaction product to form coated micro-particles, wherein step (b) comprises disposing the coated micro-particles in the base material.

14. The method of claim 11 further comprising coating each of the plurality of micro-particles with a first coating that is substantially transparent to the scintillation light to form coated micro-particles and coating each of the plurality of the micro-particles with a second coating that emits the scintillation light when exposed to the neutron reaction product to form double-coated micro-particles, wherein step (b) comprises disposing the double-coated micro-particles in the base material.
